(19) United States
(12) Patent Application Publication
(10) Pub. No.: US 2023/0097430 A1
(43) Pub. Date: Mar. 30, 2023

(54) DATA TRANSMISSION DEVICE AND IMAGE PROCESSING APPARATUS CAPABLE OF SUPPRESSING REDUCTION IN IMAGE QUALITY OF IMAGE DATA TO BE TRANSMITTED

(71) Applicant: KYOCERA Document Solutions Inc., Osaka (JP)

(72) Inventor: Yukio Shibata, Osaka (JP)

(21) Appl. No.: 17/936,313

(22) Filed: Sep. 28, 2022

(30) Foreign Application Priority Data
Sep. 29, 2021 (JP) 2021-158756

(51) Int. Cl. H04N 5/235; G06F 13/14

(52) U.S. Cl. CPC H04N 5/235; G06F 13/14

(57) ABSTRACT

A data transmission device includes a data identification portion, an error determination portion and an output control portion. The data identification portion, based on a detected position of a predetermined bit string in a bit string received via a serial transmission path, identifies a plurality of parallel data corresponding to one line of image data included in the bit string. The error determination portion determines whether or not there is an error in each of the parallel data identified by the data identification portion. The output control portion, in a case where it is determined that none of the plurality of parallel data has an error, outputs the plurality of parallel data and stores the plurality of parallel data in a storage portion, and in a case where it is not determined that there is no error, outputs the plurality of parallel data stored in the storage portion.

### INCORPORATION BY REFERENCE

This application is based upon and claims the benefit of priority from the corresponding Japanese Patent Application No. 2021-158756 filed on Sep. 29, 2021, the entire contents of which are incorporated herein by reference.

### BACKGROUND

The present disclosure relates to a data transmission device and an image processing apparatus.

An image processing apparatus such as a multifunction peripheral includes a data transmission device that transmits image data. For example, the data transmission device includes a data input portion, a data transmitting portion, a serial transmission path, a data receiving portion, and a data output portion.

A plurality of parallel data corresponding to one line of image data is input to the data input portion. The data input portion adds a predetermined second bit string to a first bit string indicating the plurality of parallel data corresponding to the one line of input image data, and outputs the first bit string to which the second bit string is added as a transmission target bit string to the data transmitting portion. The data transmitting portion uses the serial transmission path to transmit the transmission target bit string input from the data input portion. The data receiving portion receives a bit string transmitted via the serial transmission path and outputs the received bit string to the data output portion. The data output portion detects the second bit string included in the bit string input from the data receiving portion, and based on the detected position of the second bit string in the bit string, identifies the first bit string included in the bit string, that is, the plurality of parallel data corresponding to the one line of image data. The data output portion outputs the identified plurality of parallel data.

In the data transmission device, in a case where noise is mixed in the serial transmission path while the data transmitting portion is transmitting the transmission target bit string, there is a possibility that a bit omission will occur in the bit string being transmitted. When a bit omission occurs, a division position of the parallel data in the bit string input from the data receiving portion, which is identified by the data output portion, shifts from the original position. Thus, the parallel data output from the data output portion becomes abnormal data until the next second bit string is detected. On the other hand, there is a known technique for correcting the division position of the parallel data to the original position before the next second bit string is detected.

### SUMMARY

A data transmission device according to an aspect of the present disclosure includes a data transmitting portion, a data receiving portion, a data identification portion, an error determination portion, and an output control portion. The data transmitting portion uses a serial transmission path to sequentially transmit, at predetermined specific intervals, each of transmission target bit strings including a first bit string indicating a plurality of parallel data corresponding to one line of image data and a predetermined second bit string. The data receiving portion receives a bit string transmitted via the serial transmission path. The data identification portion, based on a detected position of the second bit string in a bit string received by the data receiving portion, identifies a plurality of the parallel data corresponding to the image data included in the bit string. The error determination portion determines whether or not there is an error in each of the parallel data identified by the data identification portion. The output control portion, in a case where it is determined by the error determination portion that none of the plurality of parallel data corresponding to the image data has the error, outputs the plurality of parallel data and stores the plurality of parallel data in a predetermined storage portion, and in a case where the error determination portion does not determine that none of the plurality of parallel data corresponding to the image data has the error, outputs the plurality of parallel data stored in the storage portion.

An image processing apparatus according to another aspect of the present disclosure includes the data transmission device and an image reading portion. The image reading portion reads image data from a document sheet. The data transmission device is used to transmit the image data of the document sheet from the image reading portion.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus of an embodiment according to the present disclosure.

FIG. 2 is a block diagram showing a system configuration of the image forming apparatus of an embodiment according to the present disclosure.

FIG. 3 is a block diagram showing a configuration of a data transmission portion of the image forming apparatus of an embodiment according to the present disclosure.

FIG. 4 is a diagram showing an example of a transmission target bit string transmitted by a conventional data transmission device.

FIG. 5 is a diagram showing an example of a transmission target bit string transmitted by the image forming apparatus of an embodiment according to the present disclosure.

### DETAILED DESCRIPTION

Embodiments according to the present disclosure will be described below with reference to the accompanying drawings. Note that the following embodiments are examples of implementing techniques according to the present disclosure and do not limit the technical scope of the present disclosure.

### Configuration of Image Forming Apparatus 100

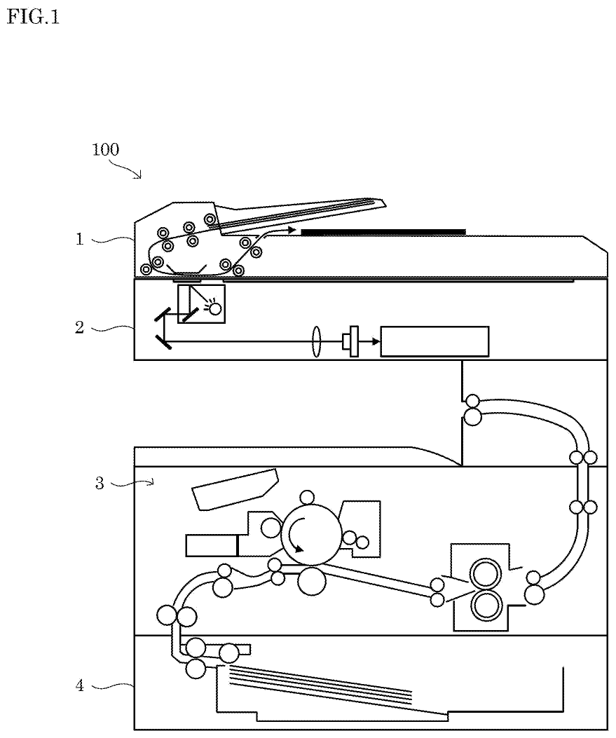

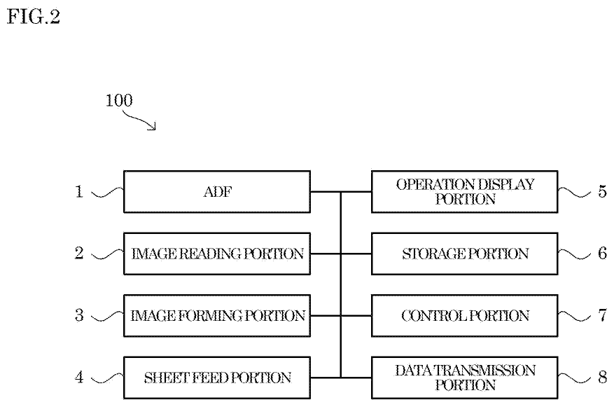

First, the configuration of an image forming apparatus 100 of an embodiment according to the present disclosure will be described with reference to FIG. 1 and FIG. 2. Here, FIG. 1 is a cross-sectional view showing the configuration of the image forming apparatus 100.

The image forming apparatus 100 is a multifunction peripheral having a plurality of functions such as a scanning function that reads an image of a document sheet, a printing function that forms an image on a sheet based on image data, a fax function, a copying function, and the like. The image forming apparatus 100 is an example of the image processing apparatus according to the present disclosure. Note that the present disclosure may be applied to image processing apparatuses such as scanners, printers, facsimiles, copiers, personal computers, notebook computers, and televisions.

As shown in FIG. 1 and FIG. 2, the image forming apparatus 100 includes an auto document feeder (ADF) 1, an image reading portion 2, an image forming portion 3, a sheet feed portion 4, an operation display portion 5, a storage portion 6, a control portion 7 and a data transmission portion 8.

The ADF 1 conveys a document sheet to be read by the scanning function. The ADF 1 includes a document setting portion, a plurality of conveying rollers, a document sheet holder, and a sheet discharge portion.

The image reading portion 2 achieves the scanning function. The image reading portion 2 has a document sheet table, a light source, a plurality of mirrors, an optical lens, and a charge coupled device (CCD).

The image reading portion 2 reads the image data of the document sheet one line at a time, and outputs the read one line of image data. More specifically, the image reading portion 2 divides the one line of read image data into a plurality of first parallel data and outputs the first parallel data. The first parallel data is an example of parallel data according to the present disclosure.

The image forming portion 3 achieves the printing function. More specifically, the image forming portion 3 forms an image by an electrophotographic method. The image forming portion 3 includes a photoconductor drum, a charging device, a laser scanning unit (LSU), a developing device, a transfer device, a cleaning device, a fixing device, and a sheet discharge tray.

The sheet feed portion 4 supplies a sheet to the image forming portion 3. The sheet feed portion 4 includes a sheet feed cassette and a plurality of conveying rollers.

The operation display portion 5 is a user interface of the image forming apparatus 100. The operation display portion 5 has a display portion such as a liquid crystal display that displays various types of information according to a control instruction from the control portion 7, and an operation portion such as operation keys or a touch panel for inputting various types of information to the control portion 7 according to user operation.

The storage portion 6 is a non-volatile storage device. For example, the storage portion 6 is a storage device such as non-volatile memory such as flash memory and EEPROM, a solid state drive (SSD), or a hard disk drive (HDD).

The control portion 7 performs overall control of the image forming apparatus 100. More specifically, the control portion 7 includes a CPU, a ROM, and a RAM. The CPU is a processor that executes various types of arithmetic processes. The ROM is a non-volatile storage device in which information such as a control program for causing the CPU to execute various types of processes is stored in advance. The RAM is a volatile or non-volatile storage device used as a temporary storage memory (work area) for various types of processes executed by the CPU. The CPU executes various types of control programs stored in advance in the ROM. Thus, the CPU performs overall control of the image forming apparatus 100.

### Configuration of Data Transmission Portion 8

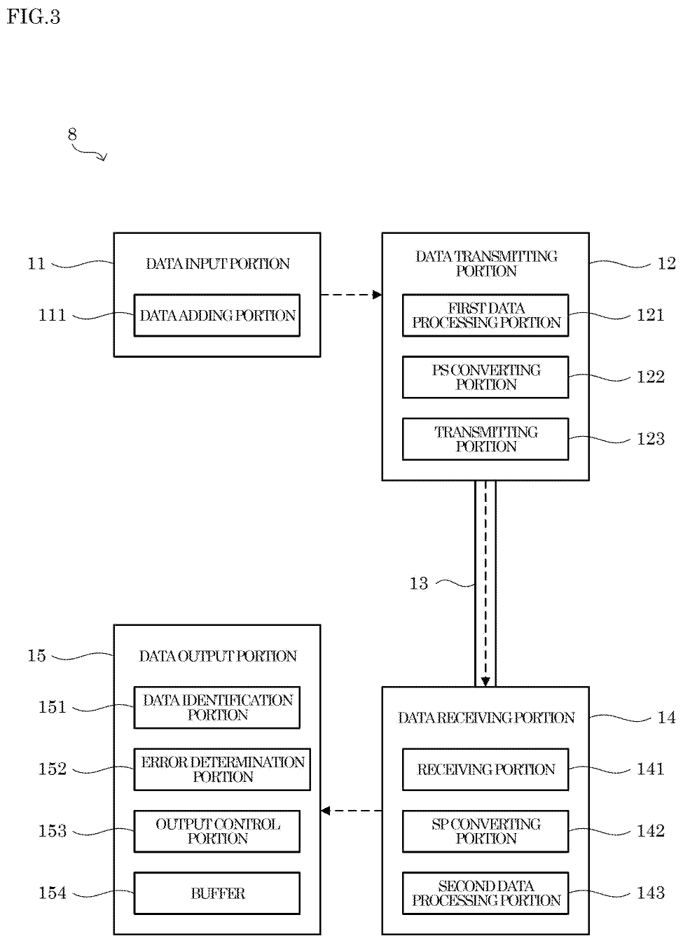

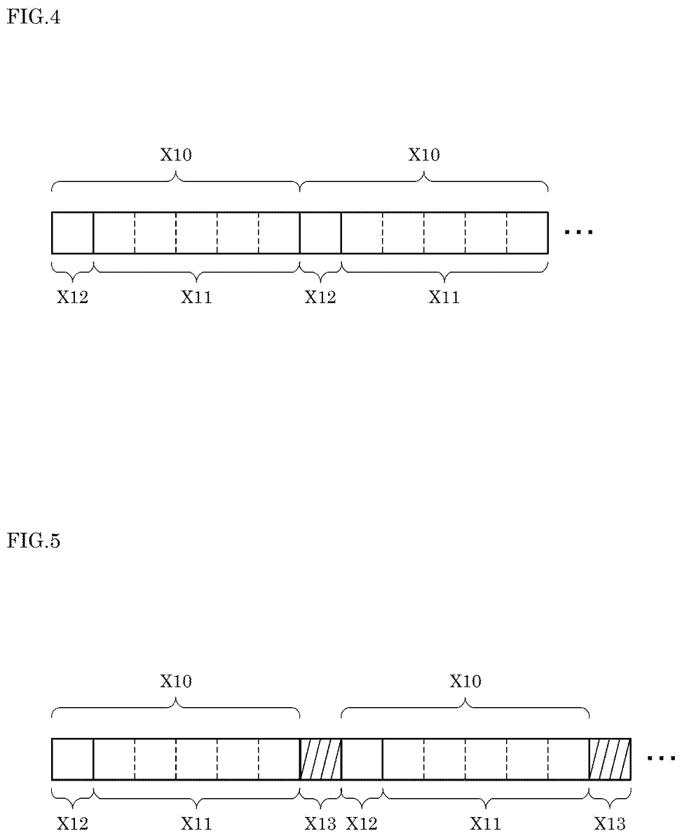

Next, the configuration of the data transmission portion 8 will be described with reference to FIG. 3 to FIG. 5. Here, FIG. 4 is a diagram showing a plurality of transmission target bit strings X10 transmitted by a conventional data transmission device. In addition, FIG. 5 is a diagram showing a plurality of transmission target bit strings X10 transmitted by the data transmission portion 8. Note that the dashed lines with arrows in FIG. 3 indicate input/output data. In addition, the dashed lines in FIG. 4 and FIG. 5 indicate division positions of the first parallel data in the first bit string X11. Note that in FIG. 5, a figure indicating a third bit string X13 is hatched.

The data transmission portion 8 is used to transmit image data of a document sheet from the image reading portion 2. More specifically, the data transmission portion 8 is used to transmit image data read by the image reading portion 2 to the control portion 7. The data transmission portion 8 is an example of the data transmission device according to the present disclosure.

As shown in FIG. 3, the data transmission portion 8 includes a data input portion 11, a data transmitting portion 12, a serial transmission path 13, a data receiving portion 14, and a data output portion 15. The data input portion 11, the data transmitting portion 12, the data receiving portion 14, and the data output portion 15 are each configured by an electronic circuit such as an integrated circuit (ASIC, DSP, FPGA).

A plurality of first parallel data corresponding to one line of image data output from the image reading portion 2 are input to the data input portion 11.

In a case where a plurality of first parallel data corresponding to one line of image data is input from the image reading portion 2, the data input portion 11 adds a predetermined second bit string X12 (see FIG. 4) to the first bit string X11 (see FIG. 4) indicating the plurality of first parallel data. For example, the data input portion 11 adds the second bit string X12 to the beginning of the first bit string X11.

In addition, the data input portion 11 also outputs the transmission target bit string X10 (see FIG. 4) including the first bit string X11 and the second bit string X12 to the data transmitting portion 12. More specifically, the data input portion 11 divides the transmission target bit string X10 into a plurality of second parallel data and outputs the second parallel data. The second parallel data is 8-bit parallel data.

The data transmitting portion 12 uses the serial transmission path 13 to transmit the transmission target bit string X10 (see FIG. 4) input from the data input portion 11. As shown in FIG. 3, the data transmitting portion 12 is connected to the data receiving portion 14 via the serial transmission path 13.

As shown in FIG. 3, the data transmitting portion 12 includes a first data processing portion 121, a PS converting portion 122 and a transmitting portion 123.

The first data processing portion 121 executes a predetermined first data process on the second parallel data input from the data input portion 11. For example, the first data process is an encoding process according to the 8 B/10 B encoding method. The first data processing portion 121 outputs third parallel data, generated based on the second parallel data by executing the first data process, to the PS converting portion 122.

The PS converting portion 122 converts the third parallel data input from the first data processing portion 121 into serial data. The PS converting portion 122 outputs the converted serial data to the transmitting portion 123.

The transmitting portion 123 transmits a bit string indicating the serial data input from the PS converting portion 122 to the data receiving portion 14 via the serial transmission path 13.

The data receiving portion 14 receives a bit string transmitted via the serial transmission path 13.

As shown in FIG. 3, the data receiving portion 14 includes a receiving portion 141, an SP converting portion 142, and a second data processing portion 143.

The receiving portion 141 receives a bit string indicating serial data transmitted from the data transmitting portion 12 via the serial transmission path 13. The receiving portion 141 outputs the received serial data to the SP converting portion 142.

The SP converting portion 142 converts the serial data input from the receiving portion 141 into the third parallel data. In other words, the SP converting portion 142 restores the third parallel data based on the serial data input from the receiving portion 141. The SP converting portion 142 outputs the restored third parallel data to the second data processing portion 143.

The second data processing portion 143 executes a second data process corresponding to the first data process on the third parallel data input from the SP converting portion 142. For example, the second data process is a decoding process corresponding to the encoding process. The second data processing portion 143 outputs the second parallel data generated (restored) based on the third parallel data by the second data process.

The second parallel data output from the data receiving portion 14 is input to the data output portion 15.

As shown in FIG. 3, the data output portion 15 includes a data identification portion 151, an error determination portion 152, an output control portion 153, and a buffer 154.

The data identification portion 151 detects the second bit string X12 (see FIG. 4) from the bit string received by the data receiving portion 14.

More specifically, the data identification portion 151 detects the second bit string X12 from the bit string indicating the second parallel data output from the data receiving portion 14.

The data identification portion 151, based on the detection position of the second bit string X12 in the bit string received by the data receiving portion 14, identifies the first bit string X11 (see FIG. 4) included in the bit string, that is, the plurality of first parallel data corresponding to one line of image data.

The error determination portion 152 determines whether or not there is an error in each of the first parallel data identified by the data identification portion 151.

More specifically, the first parallel data includes an error detection code for detecting whether or not the bit string indicating the first parallel data has changed. The error determination portion 152 uses the error detection code included in the first parallel data to determine whether or not there is an error, that is, whether or not the bit string indicating the first parallel data has changed.

In the data transmission portion 8, in a case where noise enters the serial transmission path 13 while the data transmitting portion 12 is transmitting the transmission target bit string X10 (see FIG. 4), there is a possibility that bit omission will occur in the bit string being transmitted. When a bit omission occurs, a division position of the first parallel data in the bit string input from the data receiving portion 14, which is identified by the data identification portion 151, becomes a position shifted from the original position. Thus, the first parallel data output from the data output portion 15 becomes abnormal data until the next second bit string X12 (see FIG. 4) is detected. On the other hand, there is a known technique for correcting the division position of the first parallel data to the original position before the next second bit string X12 is detected.

Even when the division position of the first parallel data is corrected to the original position before the next second bit string X12 is detected, the image quality of the image data to be transmitted may decrease due to the abnormal data output until the correction is made. On the other hand, the data transmission portion 8 has an output control portion 153 described below.

The output control portion 153, in a case where the error determination portion 152 determines that there is no error in any of the plurality of first parallel data corresponding to one line of image data, outputs the plurality of first parallel data and stores the plurality of first parallel data in the buffer 154. The buffer 154 is an example of the storage portion according to the present disclosure.

In addition, the output control portion 153, in a case where the error determination portion 152 does not determine that there is no error in any of the plurality of first parallel data corresponding to one line of image data, outputs the plurality of first parallel data stored in the buffer 154.

More specifically, the output control portion 153, in a case where the error determination portion 152 determines that there is error in one of the plurality of first parallel data corresponding to one line of image data, outputs the plurality of first parallel data stored in the buffer 154. In addition, the output control portion 153, in a case where the identification of the plurality of first parallel data corresponding to one line of image data by the data identification portion 151 fails, outputs the plurality of first parallel data stored in the buffer 154. In other words, the output control portion 153, in a case where the data identification portion 151 fails to detect the second bit string X12, outputs the plurality of first parallel data stored in the buffer 154.

That is, the output control portion 153, in a case where the transmission target bit string X10 is not normally received by the data receiving portion 14, alternatively outputs the plurality of first parallel data corresponding to one line of image data stored in the buffer 154 in advance. Thus, it is possible to suppress a decrease in image quality of image data to be transmitted.

However, even when a configuration for alternatively outputting the first parallel data stored in the buffer 154 is adopted, in a case where a plurality of transmission target bit strings X10 are continuously transmitted by the data transmitting portion 12 with no interval, the image quality of the image data to be transmitted may be significantly decreased (see FIG. 4). More specifically, in a case where noise enters the serial transmission path 13 while the data transmitting portion 12 is transmitting a bit string in a range including a trailing end of the transmission target bit string X10 and a leading end of the next transmission target bit string X10, the alternate output of the first parallel data stored in the buffer 154 is executed often for one line, and the image quality of the image data to be transmitted may decrease accordingly.

On the other hand, with the image forming apparatus 100 of an the embodiment according to the present disclosure, as described below, it is possible to suppress a decrease in image quality of image data to be transmitted.

More specifically, the data transmitting portion 12 sequentially transmits each of the transmission target bit strings X10 at predetermined specific intervals (see FIG. 5).

For example, the data input portion 11 includes a data adding portion 111 shown in FIG. 3.

The data adding portion 111 adds a third bit string X13 (see FIG. 5) having a bit width corresponding to the specific interval to each end of the transmission target bit string X10.

More specifically, the data adding portion 111 adds the third bit string X13 to the rear end of each transmission target bit string X10. Note that the data adding portion 111 may add the third bit string X13 to the leading end of each transmission target bit string X10.

For example, the bit width corresponding to the specific interval is the same as the bit width of the second parallel data. Note that the specific interval is preferably determined based on a width (number of bits) of bit errors that occur in the bit string being transmitted in a case where noise mixed in the serial transmission path 13 is investigated and the investigated noise is mixed in.

The data transmitting portion 12 sequentially transmits each transmission target bit string X10 to which the third bit string X13 is added (see FIG. 5).

Thus, the transmission target bit string X10 is sequentially transmitted at the specific interval. Therefore, even when noise enters the serial transmission path 13 during transmission of the transmission target bit strings X10 by the data transmitting portion 12, the noise is suppressed from adversely affecting two transmission target bit strings X10 at the same time. Therefore, it is possible to suppress a decrease in the image quality of the image data to be transmitted due to execution of alternate output of the first parallel data stored in the buffer 154 for two lines.

Note that instead of transmitting the third bit string X13, the data transmitting portion 12 may stop transmitting the bit string until time corresponding to the specific interval has elapsed. In this case, the data input portion 11 does not have to include the data adding portion 111.

### Other Embodiments

Note that the data transmission portion 8 may be used to transmit image data to be printed to the image forming portion 3. In addition, the data transmission portion 8 may be used to transmit image data to be displayed to the operation display portion 5.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A data transmission device, comprising:
a data transmitting portion configured to use a serial transmission path to sequentially transmit, at predetermined specific intervals, each of transmission target bit strings including a first bit string indicating a plurality of parallel data corresponding to one line of image data and a predetermined second bit string;
a data receiving portion configured to receive a bit string transmitted via the serial transmission path;
a data identification portion configured, based on a detected position of the second bit string in a bit string received by the data receiving portion, to identify a plurality of the parallel data corresponding to the image data included in the bit string;
an error determination portion configured to determine whether or not there is an error in each of the parallel data identified by the data identification portion; and
an output control portion configured, in a case where it is determined by the error determination portion that none of the plurality of parallel data corresponding to the image data has the error, to output the plurality of parallel data and store the plurality of parallel data in a predetermined storage portion, and in a case where the error determination portion does not determine that none of the plurality of parallel data corresponding to the image data has the error, to output the plurality of parallel data stored in the storage portion.

2. The data transmission device according to claim 1, further comprising
a data adding portion configured to add a third bit string having a bit width corresponding to the specific interval to an end of each of the transmission target bit strings; wherein
the data transmitting portion sequentially transmits each of the transmission target bit strings to which the third bit string is added.

3. A image processing apparatus, comprising:
the data transmission device according to claim 1; and
an image reading portion configured to read image data of a document sheet; wherein
the data transmission device is used to transmit the image data of the document sheet from the image reading portion.
